(19) United States
(12) Patent Application Publication
(10) Pub. No.: US 2014/0366583 A1
(43) Pub. Date: Dec. 18, 2014

(54) GLASS FURNACE, IN PARTICULAR FOR CLEAR OR ULTRA-CLEAR GLASS, WITH LATERAL SECONDARY RECIRCULATIONS

(71) Applicants: Wolf Stefan Kuhn, Maisons Alfort (FR); Samir Tabloul, Maisons Alfort (FR)

(72) Inventors: Wolf Stefan Kuhn, Maisons Alfort (FR); Samir Tabloul, Maisons Alfort (FR)

(73) Assignee: FIVES STEIN, Maisons Alfort (FR)

(21) Appl. No.: 14/110,392

(22) PCT Filed: Apr. 5, 2012
(86) PCT No.: PCT/IB2012/051686

§ 371 Date: Dec. 11, 2013

(30) Foreign Application Priority Data
Apr. 6, 2011 (FR) 1152959

(51) Int. Cl. C03B 5/183

(52) U.S. Cl. CPC C03B 5/183
USPC 65/356

(57) ABSTRACT

Glass furnace for heating and melting materials to be vitrified, in which furnace two molten glass recirculation loops are formed in the bath between a hotter central zone of the furnace and, respectively, the inlet (E) and the outlet (Y) which are at a lower temperature; the furnace comprises lateral cooling means (12a), (12b) so as to create or strengthen lateral secondary recirculation rolls (B2La), (B2Lb) of the glass.

The invention relates to a double recirculation current glass furnace for heating, melting and fining materials to be vitrified, this furnace being of the type of those that comprise:

an entrance for raw materials;

a superstructure equipped with heating means;

a tank containing a melt of molten glass on which a blanket of raw materials floats from the entrance as far as a certain distance into the furnace; and

an exit via which molten glass is removed.

The invention more particularly, but not exclusively, relates to a furnace for clear or ultra-clear glass.

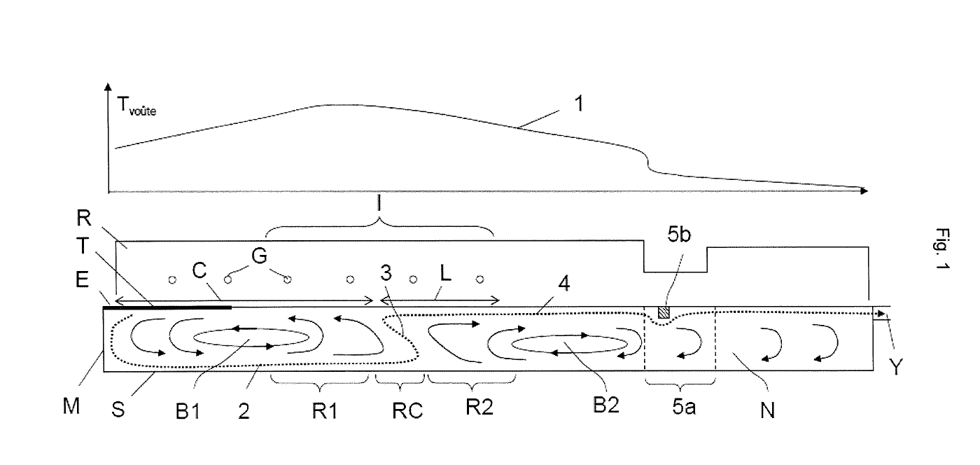

With reference to the schematic in FIG. 1 of the appended drawings, a conventional float glass furnace may be seen with an entrance E for raw materials, a superstructure R equipped with burners G, a tank M the bottom S of which supports a melt N of molten glass on which a blanket T of raw materials floats from the entrance, and an exit Y. Above the furnace, the variation in the temperature of the hot side of the crown T_{crown} of the superstructure R, along the length of the furnace, is plotted on the y-axis in FIG. 1, and is represented by the curve 1 the maximum of which is located in the central zone I of the tank.

Two recirculation loops B1, B2 of pool of glass form in the melt between a hotter central zone I of the furnace and the entrance E and exit Y, respectively, which are at a lower temperature. In FIG. 1, the recirculation in the primary loop B1 takes place in the anticlockwise direction: glass at the surface flows from the zone I toward the entrance E, descends toward the bottom and returns in the bottom part of the melt toward the central zone I before rising toward the surface. The recirculation in the secondary loop B2 takes place in the opposite direction, i.e. in the clockwise direction. These two recirculation loops have an influence on the principal flow of glass pulled from the furnace. They modify the shape and the duration of the travel of the principal flow depending on their strength.

The shortest path the main flow can take, corresponding to the shortest dwell time, which is critical to the quality of the glass extracted frost the furnace, is schematically shown by the dotted line 2, according to which glass, near the entrance, moves to near the bottom S, then rises along a relatively sinuous path 3 between the two recirculation loops in order then to move along a trajectory 4, in the vicinity of the top level of the melt, toward the exit Y. The upward trajectory 3 corresponds to a central spring zone RC comprised between the two loops B1, B2 and their spring zones R1 and R2. The turning point of the flow of glass at the surface of the melt marks the point of separation of the spring zones R1 and RC at the surface. The distance between the entrance of the furnace and this turning point defines the length C shown in FIG. 1, which length is representative of the extent of the loop B1. It may be determined experimentally or by numerical simulation. The fining quality of the glass is determined by the initial portion of the trajectory 4. In this initial portion, the glass is kept at a temperature above the fining temperature (about 1450° C. for soda-lime glass) for a certain length of time. The dwell time in the initial portion of the trajectory 4 therefore determines the quality of the glass produced. This dwell time is given by the length L of the zone that is at a temperature of above about 1450° C., for soda-lime glass, and by the flow velocity of the glass. This glass flow velocity is related to the pull rate obtained at the exit of the furnace and to the strength of the recirculation B2.

It is thus a target to maximize the “fining” dwell time in order to improve the quality of the glass, or to increase the pull rate of the furnace for a given quality. The dwell time may be increased by slowing down the secondary recirculation, thereby also allowing furnace consumption to be decreased. Thus, a restriction in furnace width, called a waist 5a, has, for a number of years, been added to float glass furnaces. In addition, use may be made, in this waist 5a, of a water-cooled barrier 5b, which further slows down the recirculation. Moreover, this recirculation loop is essential for creating the spring zone in the center of the tank on interaction with the first loop. Cooling in the waist and in the working end ensures the operation of the secondary loop by decreasing the temperature of the glass.

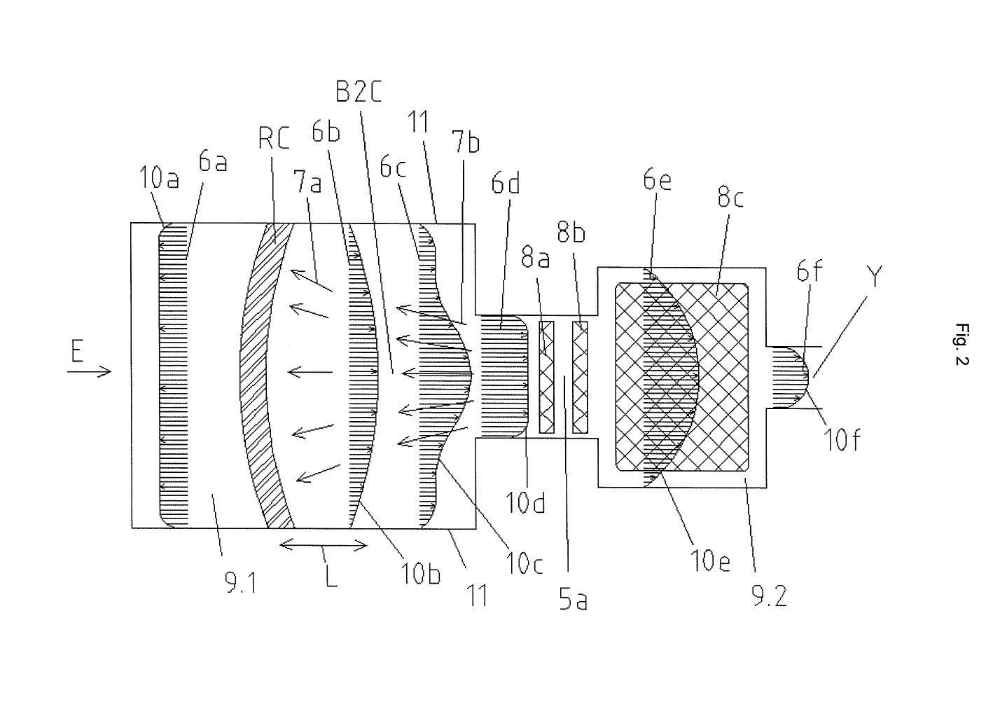

With reference to the schematic in FIG. 2 of the appended drawings, a schematic top view of the conventional furnace shown in FIG. 1 may be seen.

In FIG. 2, the flow of glass at the surface is shown by parallel horizontal arrows 6a, 6b, 6c, 6d, 6e, 6f that terminate on a continuous line 10a, 10b, 10c, 10d, 10e, 10f. The length of the arrows 6a-6f represents the flow velocity. The position of the continuous lines 10a-10f is representative of the direction of flow of the glass: the glass flows from that end of the arrows 6a-6f not making contact with the continuous line 10a-10f toward the other end that makes contact with the line 10a-10f. The flow of glass near the bottom of the melting tank 9.1, for the loop B2, is shown by the arrows 7a and 7b. The conventional zones used to cool the glass, 8a and 8b in the waist and 8c in the working end 9.2, are also shown in this figure.

The arrows 6a show glass flowing at the surface toward the entrance of the furnace, this flow being related to the primary recirculation current. The arrows 6b show glass flowing at the surface toward the exit of the furnace, this flow being related to the secondary recirculation current. The spring zone RC is located between the two.

As the arrows 6b show, the velocity at which glass moves at the surface is higher at the center of the furnace and gradually decreases toward the edges of the furnace.

As the arrows 6c show, this effect progressively increases as the waist 5a is approached. Thus, the narrowing of the melting tank causes concentration of the surface flow of the secondary loop before it enters into the waist in the center of said tank. Increasing velocity in this zone decreases fining time.

As the arrows 7a and 7b show, the return flow of glass along the bottom of the melting tank is not at all uniform over the width of the melting tank. In the vicinity of the waist, in the corners of the tank, there are therefore two “dead” zones 11 where the flow of glass is very limited.

The aim of the invention, above all, is to provide a double recirculation loop glass furnace that does not have, or has to a lesser extent, the drawbacks recalled above and that, in particular, allows a high fining quality to be obtained, not only for ultra-clear glass but also for clear and ordinary glass.

According to the invention, the glass furnace for heating and melting materials to be vitrified, especially, but not exclusively, comprises:

an entrance E for raw materials;

a superstructure R equipped with heating means G;

a tank M containing a melt of molten glass on which a blanket T of raw materials floats from the entrance as far as a certain distance into the furnace; and

an exit Y via which molten glass is removed,

two molten glass recirculation loops B1, B2 forming in the melt N between a hotter central zone I of the furnace and the entrance and exit, respectively, which are at a lower temperature;

and is characterized in that it comprises means for cooling the glass, which means are located in the vicinity of the lateral sides of the furnace on either side and upstream of a restriction, such as a waist, a channel, or a overflow, so as to create or increase lateral secondary recirculation currents of glass in order to decrease the strength of the central secondary loop.

Localized lateral cooling of the glass according to the invention leads to a decrease in the temperature of the glass and therefore an increase in its density. The heavier glass descends toward the bottom then flows toward the hotter central zone I of the furnace.

Preferably, the means for cooling the glass are located in the vicinity of the entrance of the waist, in particular in the corners of the tank.

Advantageously, the means for cooling the glass are located near the surface of the melt. They are especially overhead coolers placed above the glass melt, or coolers submerged in the melt and especially cooled with water.

In order to establish a spring zone in the center of the furnace, the two recirculation loops must possess a comparable driving force. This driving force is created on the one hand by energy consumption by the bottom side of the batch blanket. On the other hand, cooling in the waist and working end combined creates the driving force of the secondary loop. According to the invention, lateral secondary glass recirculation currents contribute to the driving force of the secondary loop.

According to the invention, conventional cooling is partially or completely replaced by lateral cooling before the entrance of the waist. Completely replacing conventional cooling with lateral cooling is especially advantageous for waist or overflow type furnaces with a weak or absent return 7b of cold glass. Two lateral loops B2La and B2Lb are created in this way, which loops reinforce the driving force of the secondary recirculation current B2. This reinforcement allows the strength of the central loop B2C to be decreased and thus the surface flow velocity in the central zone, before the entrance of the waist, to be decreased. This results in an increase in the dwell time of the glass in the fining zone, and therefore a better fining quality for the glass.

For an equivalent glass fining quality, this solution allows the size of the working end 9.2 to be reduced, this reduction being related to the decrease in cooling required in the working end, or the pull rate from the furnace to be increased.

The invention also allows the glass flow velocity to be decreased at the corners of the entrance of the waist, thereby limiting the risk that these corners will be corroded.

The invention consists, apart from the arrangements described above, in a certain number of other arrangements that will be discussed more explicitly below with regard to a completely nonlimiting embodiment described with reference to the appended drawings. In these drawings:

FIG. 1 is a schematic vertical cross section through a conventional float glass furnace;

FIG. 2 is a schematic top view of the float glass furnace in FIG. 1; and

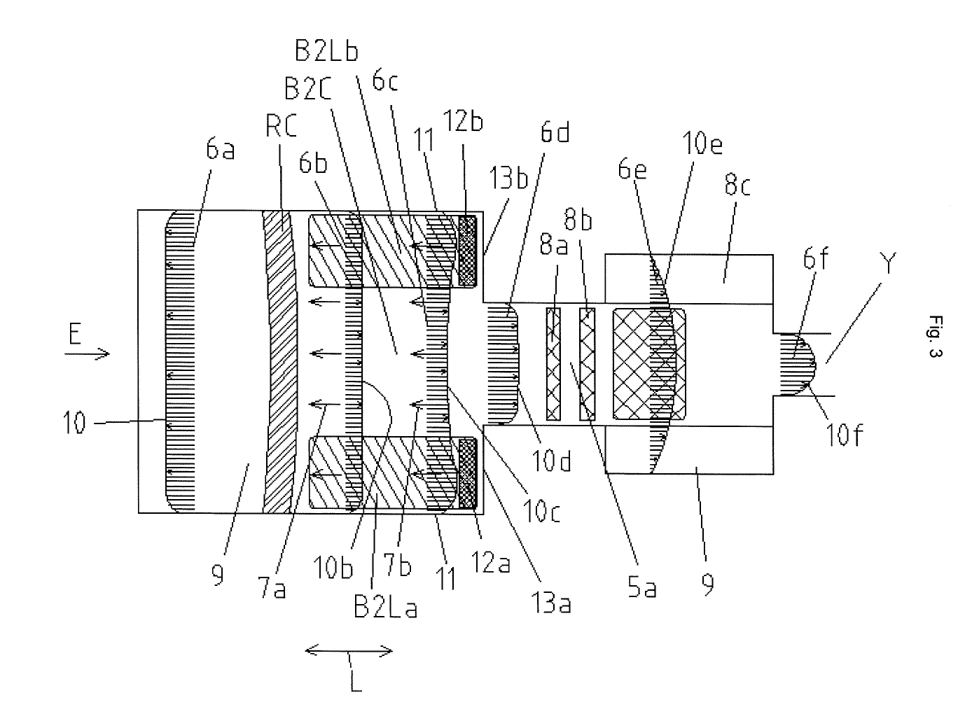

FIG. 3 is a schematic top view, similar to that in FIG. 2, of a float glass furnace according to the invention.

As FIG. 3 shows, the invention allows the position of the spring zone to be maintained despite a decrease of the central secondary recirculation B2C. This results in a better distribution in the flow velocity of the glass before the waist.

As the arrows 7a, 7b in FIG. 3 show, the existence of the lateral loops B2La, B2Lb results in a flow of glass along the bottom that is more uniform over the width of the tank and in particular toward the edges 11 of the furnace.

To obtain a notable lateral cooling effect, the heat flux evacuated by the lateral coolers must be at least 5% of the flux consumed to melt the blanket of raw materials. The energy required to melt the blanket is in part delivered to the top surface of the blanket, by radiation from the combustion chamber, and in part to the bottom side of the blanket, by convection from the recirculation loop B1. The contribution of each of these two supplies of energy to melting the blanket varies depending on the furnace design. It is typically about 50/50%. To obtain a notable lateral cooling effect, the energy flux evacuated by this lateral cooling must be at least 10% of the flux to the bottom side of the blanket.

Operation of float glass furnaces, generally called float furnaces, requires the exit of the furnace to be kept at a constant temperature, typically 1100° C. The cooling in the waist and working end is adjusted to maintain this temperature. The pull of the glass in combination with the central recirculation of the loop B2C constitutes the supply of heat to the working end.

As FIG. 3 shows, adding lateral cooling means 12a, 12b located in the vicinity of the lateral sides 13a, 13b of the furnace, on either side and upstream of the waist, allows the cooling required in the waist, and above all in the working end 9.2, to be reduced. The cooling means 12a, 12b are preferably located in the vicinity of the entrance of the waist, in particular in the corners of the tank. The lateral cooling means 12a, 12b make it possible to create or strengthen the lateral recirculation currents or loops B2La, B2Lb, in which recirculation of molten glass takes place in the same direction as for the central secondary loop B2C. Implementing the invention makes it possible to decrease the central recirculation strength of the loop B2, for example by changing the depth of the barrier 5b or the cross section of the waist. The temperature of the glass at the exit of the furnace is maintained in this way. Decreasing the cooling in the waist and in the working end, and slowing down the central secondary recirculation B2C are thus two associated actions. They especially make it possible to increase the dwell time of the glass for fining and also for refining, for the resorption of residual bubbles.

According to one embodiment of the invention, for a float furnace with a small capacity of 200 tonnes of soda-lime glass per day, with a raw material containing 20% cullet requiring 5 MW of power to melt the batch, the lateral cooling evacuates a power of 2×130 kW. Reducing the central recirculation loop B2C leads to an increase in the fining dwell time of 20%. For an equivalent fining time, implementing the lateral cooling according to the invention allows the pull rate of glass from the furnace to be increased.

For a float furnace, the lateral recirculation currents B2La and B2Lb make it possible to envision omitting the fraction of the secondary recirculation in the waist and in the working end. Nevertheless, the complete suppression recirculation in the waist and in the working end would prevent glass contaminated by the walls from returning into the fining part of the furnace. Depending on the quality of the glass required and the refractory materials used, it may be advantageous to maintain a residual recirculation in the waist and in the working end. The barrier device 5b with its variable depth allows this recirculation to be easily adjusted.

The absence of combustion at the end of the melting tank in standard float furnaces and losses via the walls create a certain lateral cooling of the glass at the end of the melting tank before the waist, but the energy evacuated in this way is substantially lower than 5% of the flux consumed to melt the blanket of raw materials. Increasing losses to the walls of the tank via the glass allows an improvement to be obtained but it remains very difficult to obtain enough losses to activate or strengthen the lateral secondary recirculation currents via the wails of the tank alone.

According to one embodiment of the invention, the cooling devices 12a, 12b allowing the lateral secondary recirculation currents to be created are overhead coolers. Such coolers may easily be introduced and removed from the furnace.

The surface of the melt may be cooled by an overhead cooler via radiative heat exchange between the hot surface of the melt and the cold surface of the cooler. It may also be cooled by convection, for example in the case where the cooler ejects air onto a target area of the melt. The temperature and the flow velocity of the blown air are chosen in order to avoid any devitrification risk.

In another embodiment of the invention, the cooling devices 12a, 12b allowing the lateral secondary recirculation currents B2La, B2Lb to be created are coolers submerged in the vicinity of the surface of the glass melt.

The coolers may especially be water cooled.

The cooling devices may be placed along the side wall or, preferably, on the end wall, or both.

It is advantageous, according to the invention, to place the cooling devices as close as possible to the end wall in order to keep the surface glass hot for as long as possible.

Advantageously, the cooling devices cover the entire width of the end wall except for the exit width of the glass, whether this is a waist, a channel or a overflow.

It is advantageous for the cooling devices to partially cover the exit width of the glass, so as to protect the corners at the entrance of the device through which the glass exits.

Depending on the required cooling capacity, multiple cooling devices may be provided. A plurality of types of coolers, for example overhead and submerged coolers, may also be combined.

The cooling devices may also consist in water-cooled coolers placed, on the glass side, at the level of the flux line of the glass.

1. A glass furnace for heating and melting materials to be vitrified, the furnace comprising:
an entrance (E) for raw materials;
a superstructure (R) equipped with heating means (G);
a tank (M) containing a melt of molten glass on which a blanket (T) of raw materials floats from the entrance as far as a certain distance into the furnace;
an exit (Y) via which molten glass is removed;
two molten glass recirculation loops (B1, B2) forming in the melt (N) between a hotter central zone (I) of the furnace and the entrance and exit, respectively, which are at a lower temperature; and
means for cooling the glass, which means are located in the vicinity of lateral sides of the furnace on either side and upstream of a restriction, so as to create or increase lateral secondary recirculation currents (B2La), (B2Lb) of glass in order to decrease the intensity of a central secondary loop (B2C).

2. The furnace as claimed in claim 1, wherein a heat flux evacuated by the lateral coolers is at least 5% of the flux consumed to melt the blanket of raw materials.

3. The furnace as claimed in claim 1, wherein the means for cooling the glass are located in the vicinity of the entrance of the waist, in particular in the corners of the tank.

4. The furnace as claimed in claim 1, wherein the cooling means are located near the surface of the melt.

5. The furnace as claimed in claim 1, wherein the cooling means are overhead coolers placed above the glass melt.

6. The furnace as claimed in claim 1, wherein the cooling means are coolers that are submerged in the glass melt.

7. The furnace as claimed in claim 6, wherein the submerged coolers are cooled with water.
